(19) United States
(12) Patent Application Publication
(10) Pub. No.: US 2020/0274303 A1
(43) Pub. Date: Aug. 27, 2020

(54) METHOD FOR SHIELDING AND GROUNDING A CONNECTOR ASSEMBLY FROM ELECTROMAGNETIC INTERFERENCE (EMI) USING A MALE/FEMALE JOINT STAMPED SHIELD AND CONDUCTIVE SEAL

(71) Applicant: J.S.T. CORPORATION, Farmington Hills, MI (US)

(72) Inventor: David DEMARATOS, Wixom, MI (US)

(73) Assignee: J.S.T. CORPORATION, Farmington Hills, MI (US)

(21) Appl. No.: 16/583,915

(22) Filed: Sep. 26, 2019

Related U.S. Application Data
(60) Provisional application No. 62/810,107, filed on Feb. 25, 2019.

(51) Int. Cl. H01R 13/6592; H01R 13/6581; H01R 13/52; H01R 13/6598

(52) U.S. Cl. CPC H01R 13/6592; H01R 13/6581; H01R 13/5216; H01R 13/6598; H01R 13/5205

(57) ABSTRACT

A method for shielding and grounding a connector assembly from electromagnetic interference (EMI) including at least one of a step of directing the EMI to at least an electrically conducting seal, and a step of directing the EMI to at least a male/female joint stamped shield. The EMI, generated by, e.g., at least a battery cable assembly or the like, housed within at least a male connector assembly or a female connector assembly of the connector assembly, has a flow path that is conducted through at least the electrically conductive seal and the male/female joint stamped shield of the connector assembly.

### CROSS-REFERENCE TO RELATED APPLICATION

This patent application claims priority to U.S. Provisional Patent Application No. 62/810,107 filed Feb. 25, 2019, which is hereby incorporated herein by reference in its entirety.

### BACKGROUND OF THE INVENTION

It is desired that a connector assembly (preferably a high voltage connector assembly) experiences a reduced or suppressed electromagnetic interference (EMI).

Shown in FIGS. 1 and 2 are a conventional connector assembly, generally referred to as reference number 1, which employs stamped shields for EMI shielding or containment. The conventional assembly 1 includes a female connector assembly 20 and a male connector assembly 25 joined together. Respectively contained within the female connector assembly 20 and the male connector assembly 25 are battery cable assemblies 28, 30. Surrounding the battery cable assembly 28 housed within the female connector assembly 20 is a corresponding female wire shield 5 secured therearound by a corresponding ferrule 8, the ferrule 8 being housed and contacting a female inner housing 10. A female stamped shield 13 surrounds, in part, the female inner housing 10, while the female stamped shield 13 is surrounded by a female outer housing 15. The female stamped shield 13 extends towards and connects with an intermediate stamp shield 28, which in turn connects with a male stamped shield 32. The male stamped shield 32 extends between a male inner housing 35 and a male outer housing 40, the male inner housing 35 contacting and surrounding, in part, a ferrule 44, which in turn contacts and surrounds a corresponding male wire shield 48.

Moreover, the conventional connector assembly 1, illustrated in FIG. 1, has a female terminal position assurance (TPA) device 50 and a male terminal position assurance (TPA) device 55 inserted into the female connector assembly 20 and the male connector assembly 25, respectively, for securing respective terminals therein. Plastic back covers 58, 60 are secured at respective ends of the female and male connector assemblies 20, 25. Near the plastic back cover 58 of the female connector assembly 20 is a silicone wire seal 63, while near the plastic back cover 60 of the male connector assembly 25 is a silicone wire seal 65. The junction between the female outer housing 15 and the male outer housing 40 is sealed by a silicone ring seal 70.

In the conventional connector assembly 1, the associated female inner housing 10, female outer housing 15, male inner housing 35, and male outer housing 40 are made of plastic, resin, nylon, or a non-conductive material. Similarly, in the conventional connector assembly 1, the associated seals (including the silicone wire seal 63 in the female connector assembly 20, the silicone wire seal 65 in the male connector assembly 25, and silicone ring seal 70 at the junction between the female and male connector assemblies 20, 25) are made of non-conductive materials.

Due to the conventional non-conductive resin, nylon or plastic-made female inner and outer housings 10, 15 of the female connector assembly 20, the conventional non-conductive resin, nylon or plastic-made male inner and outer housings 35, 40 of the male connector assembly 25, and the non-conductive silicone seals 63, 65, 70, the EMI generated in the conventional connector assembly 1, which employs the female stamped shield 13, intermediate stamp shield 28, and male stamped shield 32, has limited EMI grounding path, as further discussed below with respect to FIGS. 2 and 3.

As shown in FIGS. 2 and 3, the EMI, generated by, for example, the conducting battery cable assembly 28 (housed within the female connector assembly 20) and the conducting battery cable assembly 30 housed within the male connector assembly 25, have flow paths 80, 88 that travel within the conventional connector assembly 1 between the female wire shield 5 and the male wire shield 48. More particularly, the EMI generated in the conventional connector assembly 1 travels between the female wire shield 5 and the male wire shield 48 through the respective female wire shield 5 and the adjoining ferrule 8, the female stamped shield 13, the male stamped shield 32, the adjoining ferrule 44, and the respective male wire shield 48.

### SUMMARY OF THE INVENTION

This invention provides such a high voltage connector assembly for connecting to a device which, when in operation, experiences reduced or suppressed EMI. The EMI flow path, generated by, e.g., a battery cable assembly or the like, housed within a male connector assembly, is conducted, although not limited thereto, to, for example, at least a male wire shielding, a male electrically conducting seal, a male/female joint stamped shield, a female electrically conducting seal, and ultimately to a female wire shielding. Additionally, the EMI flow path, generated by, e.g., another cable assembly or the like at an opposite end of the connector assembly within a female connector assembly is, although not limited thereto, conducted to, for example, at least the female wire shielding, the female electrically conducting seal, the male/female joint stamped shield, the male electrically conducting seal, and ultimately to the male wire shielding.

### BRIEF DESCRIPTION OF THE DRAWINGS

FIG. 1 is a conventional connector assembly having a male connector assembly and a female connector assembly, which uses a stamped shield.

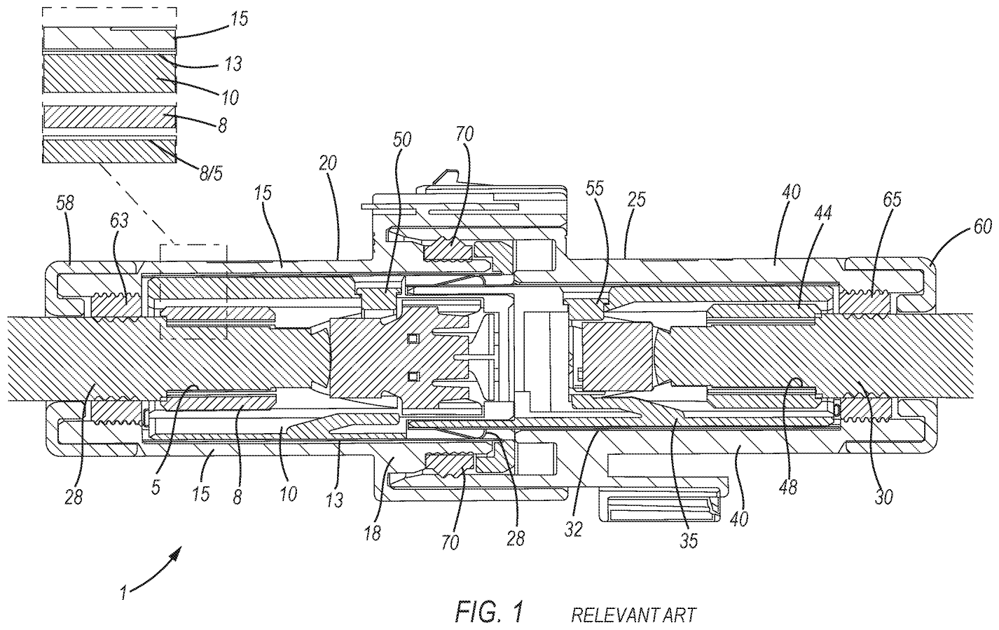

FIG. 2 shows an EMI path in the conventional connector assembly, which uses the stamped shield for EMI containment.

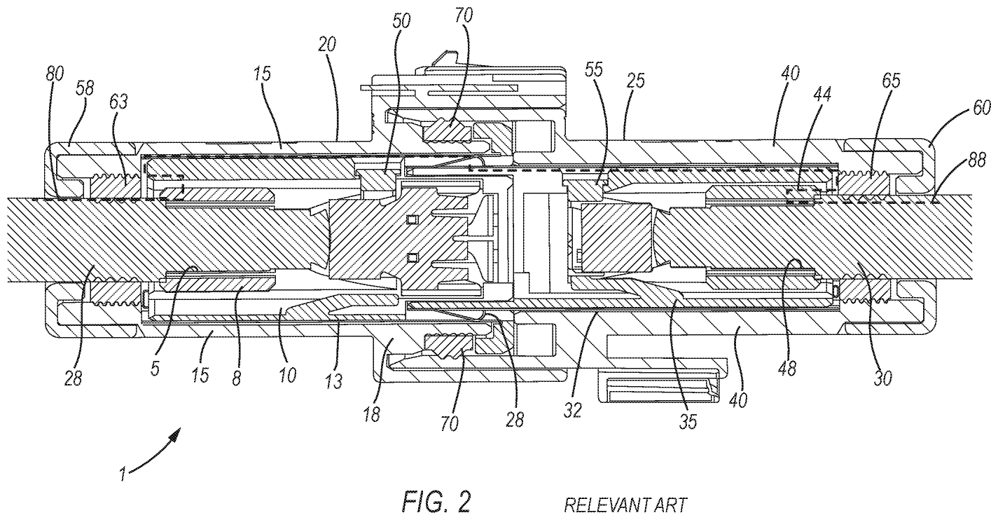

FIG. 3 is a flowchart of at least a flow path of the EMI flowing through the conventional connector assembly.

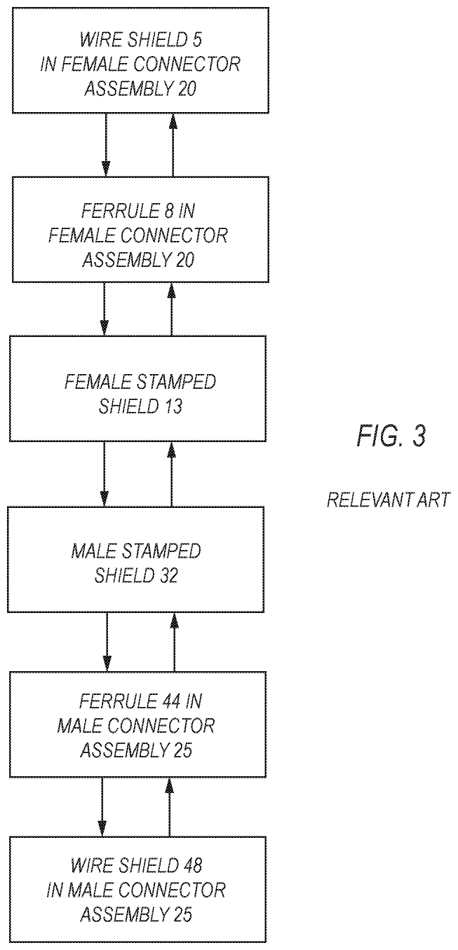

FIG. 4 is a perspective view of the male/female joint stamped shield showing the male portion and the female portion thereof.

FIG. 5 is a structural arrangement of a connector assembly having a male connector and a female connector, which illustrates the shielding and grounding of a connector assembly from the EMI using at least the male conductive seal, the male/female joint stamped shield, and the female conductive seal.

FIG. 6 shows a shielding and grounding EMI path of this invention in the connector assembly of FIG. 4, which uses at least the male conductive seal, the male/female joint stamped shield, and the female conductive seal.

FIG. 7 is a flowchart of at least a flow path of the EMI of this invention flowing through the connector assembly, with the use of at least the male conductive seal, the male/female joint stamped shied, and the female conductive seal, shown in FIGS. 5 and 6, for EMI shielding and grounding.

### DETAILED DESCRIPTION OF THE PREFERRED EMBODIMENTS

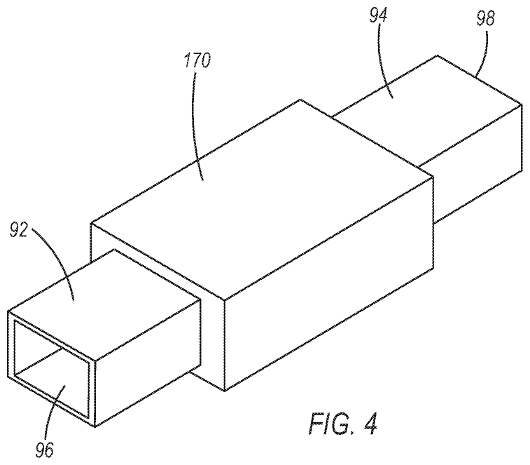

Illustrated in FIG. 4 and utilized in this invention is a male/female joint stamped shield 90, which includes a male portion 92 and a female portion 94. The male portion 92 and the female portion 94 have openings 96, 98, respectively.

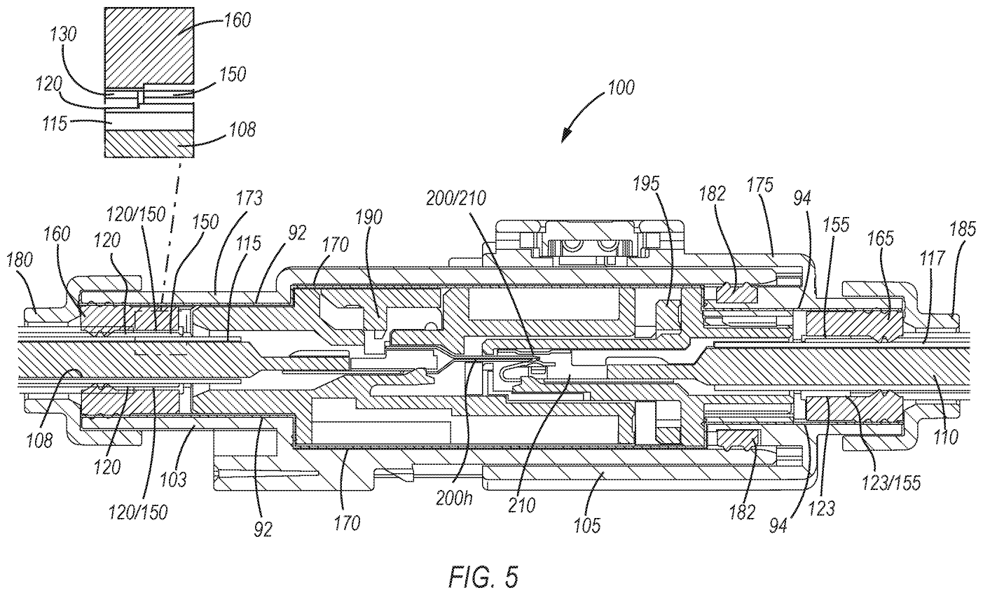

Illustrated in FIG. 5 is a first embodiment of the connector assembly of this invention, and is generally referred to as reference number 100. The connector assembly 100 of this invention is preferably a high voltage connector assembly having a male connector assembly 103 and a female connector assembly 105. The male connector assembly 103 houses a battery cable assembly 108; and on an opposite side of the connector assembly 100, the female connector assembly 105 houses another battery cable assembly 110. Surrounding the battery cable assembly 108 is an inner wire insulation 115, while the another battery cable assembly 110 is surrounded by another wire insulation 117.

In the male connector assembly 103, a wire shielding 120 surrounds the inner wire insulation 115; and while in the female connector assembly 105, a wire shielding 123 surrounds the another inner wire insulation 117. Outside the wire shielding 120, near an end portion of the male connector assembly 103, is an outer wire insulation 130. Outside the wire shielding 123, near an end portion of the female connector assembly 105, is an outer wire insulation 132. The wire shielding 120 in the male connector assembly 103, in another portion thereof, may contact a ferrule 150 (i.e., a wire shielding 120/ferrule 150 interface). At the other end of the connector assembly 100, in the female connector assembly 105, the wire shielding 123, in another portion thereof, may contact a ferrule 155 (i.e., a wire shielding 123/ferrule 155 interface). The ferrules 150, 155 are preferably metallic, conductive material, or the like.

As further illustrated in FIG. 5, an electrically conductive seal 160 surrounds the wire shielding 120 and the ferrule 150 (i.e., surrounds the wire shielding 120/ferrule 150 interface) of the male connector assembly 103. As also shown in FIG. 5, an electrically conductive seal 165 surrounds the wire shielding 123 and the ferrule 155 (i.e., surrounds the wire shielding 123 and the ferrule 155 (i.e., surround the wire shielding 123/ferrule 155 interface) of the female connector assembly 105. In the male connector assembly 103, the electrically conductive seal 160 is positioned between the wire shielding 120/ferrule 150 interface and a male/female joint stamped shield 170. In the female connector assembly 105, the electrically conductive seal 165 is positioned between the wire shielding 123/ferrule 155 interface and the male/female joint stamped shield 170.

At an end portion of the male connector assembly 103, a plastic back cover 180 shields the electrically conductive seal 160, a male end portion 92 of the stamped shield 170, and an opening 96 thereof. At an end portion of the female connector assembly 105, a plastic back cover 185 shields the electrically conductive seal 165, a female end portion 94 of the stamped shield 170, and an opening 98 thereof.

The interface between the male electrically conductive seal 160 and the female electrically conductive seal 165 is the male/female joint stamped shield 170 having the male end portion 92 and female end portion 94.

Each of the electrically conductive seal 160 of the male connector assembly 103, and the electrically conductive seal 165 of the female connector assembly 105 is made of an electrically conductive metal-infused silicone, a conductive metal-filled silicone or the like, the metal being, e.g., stainless steel or the like.

Generally contained within the male outer housing 170 and the female outer housing 175 are a male terminal position assurance (TPA) device 190, a female terminal position assurance (TPA) device 195, and a male terminal 200/female terminal 210 interface respectively extending from the battery cable assembly 108 of the male connector assembly 103 and the battery cable assembly 110 of the female connector assembly 105.

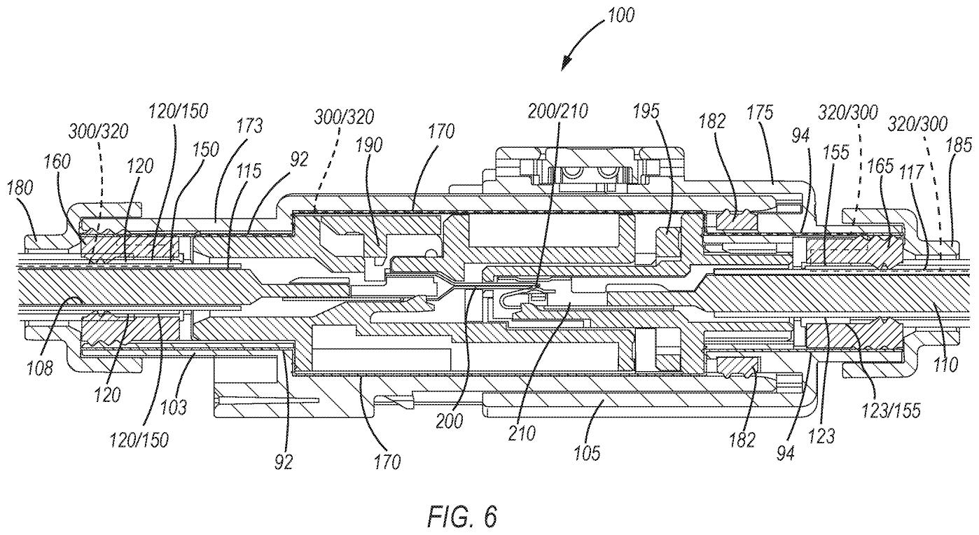

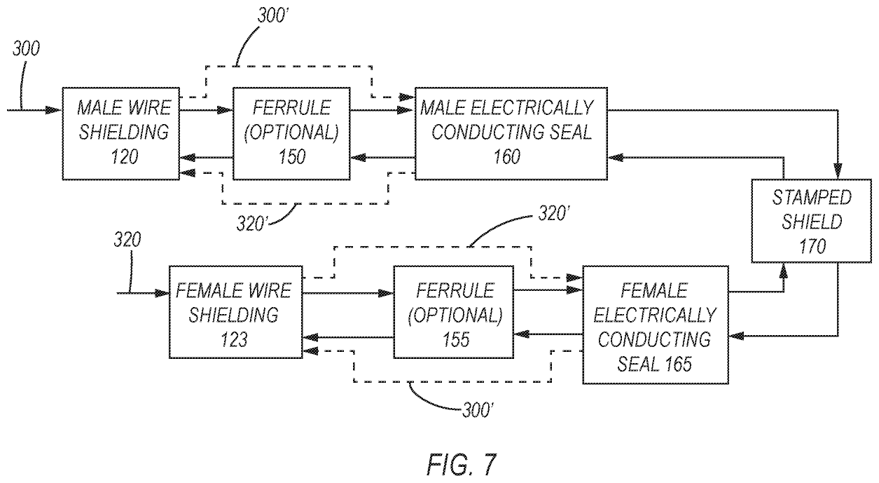

The method for shielding and grounding the connector assembly 100 of this invention from electromagnetic interference (EMI) is hereinafter described and illustrated in FIGS. 6 and 7. The EMI flow paths 300, 320 (or 300′, 320′), although each shown as a single multiple dashed lines in FIG. 6 for illustration purposes only, travel all throughout the connector assembly 100 through the various elements of the connector assembly 100, including through at least the male electrically conducting seal 160, the male/female joint stamped shield 170, and the female electrically conducting seal 165, although not limited thereto.

As illustrated in FIGS. 6 and 7, the EMI generated from, for example, the high voltage battery cable assembly 108 of the male connector assembly 103, has a flow path 300 that is conducted to the male wire shielding 120 and to the adjoining ferrule 150 (made of metal) through the male electrically conducting seal 160 (made of, e.g., stainless steel or the like fiber-filled or fiber-infused silicone or the like). The EMI is then further conducted through the male/female joint stamped shield 170, through the female electrically conducting seal 165, and through the adjoining ferrule 155 (made of metal), and then through the female wire shielding 123.

In the another embodiment of the above-described invention, the ferrule 150 in the male wire shielding 120/ferrule 150 interface of the male connector assembly 103 and the ferrule 155 of the female wire shielding 123/ferrule 155 interface of the female connector assembly 105 may be deleted and are optional components. In such a case, the EMI flow path 300′ passes through the male wire shielding 120 and directly to the male electrically conducting seal 160. Also in such a case, the EMI flow path 300′ passes through the female electrically conducting seal 165 and directly to the female wire shielding 123.

The method for shielding and grounding the connector assembly 100 of this invention from EMI is further described in relation to FIGS. 6 and 7. Here, the EMI generated from, for example, the high voltage battery cable assembly 110 or the like of the female connector assembly 105 has a flow path 320 that is conducted to the female wire shielding 123 and to the adjoining ferrule 155 (made of metal) through the female electrically conducting seal 165 (made of, e.g., stainless steel or the like fiber-filled or fiber-infused silicone or the like). The EMI is then further conducted through the male/female joint stamped shield 170. After the EMI passes through the male/female joint stamped shield 170, the EMI is further conducted through the male electrically conducting seal 160 of the male connector assembly 103, and through the adjoining ferrule 150, and ultimately to the male wire shielding 120.

In another embodiment of the invention, the ferrule 155 of the female wire shielding 123/ferrule 155 interface of the female connector assembly 105, and the ferrule 150 of the male wire shielding 120/ferrule 150 interface of the male connector assembly 103 may be deleted and are optional components. In such a case, the EMI flow path 320 passes through the female wire shielding 123 and directly to the female electrically conducting seal 165 (see, EMI flow path 320′ in FIG. 7). Also in such a case, the EMI flow path 320 passes through the male electrically conducting seal 160 and directly to the male wire shielding 120 (see, EMI flow path 320′ in FIG. 7).

Although the foregoing descriptions are directed to the preferred embodiments of the invention, it is noted that other variations and modifications will be apparent to those skilled in the art, and may be made without departing from the spirit or scope of the invention. Moreover, structures, structural arrangements, or features described in connection with one embodiment of the invention may be used in conjunction with other embodiments, even if not explicitly stated above.

I claim:

1. A method for shielding and grounding a connector assembly from electromagnetic interference (EMI), comprising at least one of:
(a) a step of directing said EMI to at least an electrically conducting seal; and
(b) a step of directing said EMI to at least a male/female joint stamped shield.

2. The method for shielding and grounding said connector assembly from said EMI according to claim 1, wherein said step of directing said EMI to said at least said male/female joint stamped shield comprises at least one of:
(i) a step of directing said EMI to a male portion of said male/female joint stamped shield, and
(ii) a step of directing said EMI to a female portion of said male/female joint stamped shield.

3. The method for shielding and grounding said connector assembly from said EMI according to claim 1, wherein said electrically conducting seal is a metal-infused or metal-filled material, and wherein said material is material selected from the group consisting of silicone and the like.

4. The method for shielding and grounding said connector assembly from said EMI according to claim 3, wherein said metal-infused or metal-filled material of said electrically conducting seal in comprised of a metal, and wherein said metal is a conductive metal selected from the group consisting of stainless steel and the like.

5. The method for shielding and grounding said connector assembly from said EMI according to claim 1, wherein said male/female joint stamped shield is made of metal.

6. A method for shielding and grounding a connector assembly from electromagnetic interference (EMI) using at least a conductive seal and a male/female joint stamped shield, comprising the steps of:
directing said EMI, generated by at least a battery cable assembly within a male connector assembly of said connector assembly, into a male wire shielding:
directing said EMI to a male electrically conducting seal;
directing said EMI to a male/female joint stamped shield;
directing said EMI to a female electrically conducting seal; and thereafter
directing said EMI to a female wire shielding.

7. The method for shielding and grounding said connector assembly from said EMI according to claim 6, further comprising:
directing said EMI, generated by at least a battery cable assembly within said female connector assembly of said connector assembly, into a female wire shielding;
directing said EMI to said female electrically conducting seal;
directing said EMI to said male/female joint stamped shield;
directing said EMI to said male electrically conducting seal; and thereafter
directing said EMI to said male wire shielding.

8. The method for shielding and grounding said connector assembly from said EMI according to claim 6,
wherein said step of directing said EMI to said male electrically conducting seal includes the step of directing said EMI to a male wire shielding/ferrule interface; and
wherein said step of directing said EMI to said female wire shielding includes the step of directing said EMI to a female wire shielding/ferrule interface.

9. The method for shielding and grounding said connector assembly from said EMI according to claim 7,
wherein said step of directing said EMI to said female electrically conducting seal includes the step of directing said EMI to a female wire shielding/ferrule interface; and
wherein said step of directing said EMI to said male wire shielding includes the step of directing said EMI to a male wire shielding/ferrule interface.

10. The method for shielding and grounding said connector assembly from said EMI according to claim 6, wherein at least one of said male electrically conducting seal and said female electrically conducting seal is a metal-infused or metal-filled material, and wherein said material is material selected from the group consisting of silicone and the like.

11. The method for shielding and grounding said connector assembly from said EMI according to claim 10, wherein said metal-infused or metal-filled material of at least one of said male electrically conducting seal, and said female electrically conducting seal is comprised of metal, and wherein said metal is a conductive metal selected from the group consisting of stainless steel and the like.

12. The method for shielding and grounding said connector assembly from said EMI according to claim 6, wherein said male/female joint stamped shield is made of metal.
